(19) United States
(12) Patent Application Publication
(10) Pub. No.: US 2010/0019185 A1
(43) Pub. Date: Jan. 28, 2010

(54) ELECTRICALLY CONDUCTIVE BONDING MEANS FOR DEVICE COMPONENTS

(75) Inventors: Justin A. Tanner, Queen Creek, AZ (US); Dave Tornquist, Chandler, AZ (US); Mike Borns, Queen Creek, AZ (US); Jim Hoffman, Chandler, AZ (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/177,643

(22) Filed: Jul. 22, 2008

(51) Int. Cl. H05F 3/02; B23K 1/00; F16K 51/00; B23K 1/20

(52) U.S. Cl. 251/366; 228/101; 228/246; 361/218; 361/220; 251/368

(57) ABSTRACT

A bonding means for electrically coupling a first component and a second component at an interface. The bonding means including at least one electrically conductive bonding puck positioned between the first component and the second component. The bonding puck being disposed within a recess formed in at least one of the first component and the second component. The at least one electrically conductive bonding puck providing electrical bonding between the first component and the second component and establishing electrical continuity therebetween.

### TECHNICAL FIELD

The present invention generally relates to the joining of device components, and more particularly relates to the electrical bonding of device components in a manner that provides electrical conductivity between the components.

### BACKGROUND

Valve assemblies are commonly used in aircraft applications to control the flow of a fluid. Some specific examples of valve assemblies utilized in aircraft applications include those commonly found in environmental control systems and may include high stage bleed air valves, mid-stage bleed air valves, bleed air isolation valves, pressure regulating and shutoff valves, load control valves, anti-ice valves, trim air valves, and temperature control valves.

In one specific example, an air turbine starter (ATS) within a turbofan jet engine may be coupled to a high pressure fluid source such as compressed air. The flow of compressed air may be controlled by, for example, a valve, such as a pneumatic valve. The flow of compressed air impinges upon a turbine wheel in the ATS causing it to rotate at a relatively high rate of speed.

It is well-known that valve assemblies may be partially disposed within an airway to control the flow of a fluid (e.g., air) there through and thus perform any one of a number of functions (e.g., temperature regulation). Valve assemblies of this type typically comprise a valve (e.g., a butterfly valve) that is coupled by way of a linkage assembly to an actuator. Static electrical discharge generated by the valve assembly or lightning strikes may damage the turbine engine as well as other aircraft systems. Previous attempts to alleviate this problem include the fastening of a p-clamp and/or a bonding strap between components of the valve assembly and a remote ground point, such as an associated component. The p-clamp or bonding strap provides a discharge path for the static electricity in the device. Although this type of bonding or grounding of the valve operates safely this method can suffer certain drawbacks. For instance, the p-clamp or bonding strap may rotate or move where clamping or attachment takes place. This relative motion of the p-clamp or bonding strap can potentially result in an increase in the bonding resistance across the joint and the buildup of static electricity within the valve assembly. Furthermore, the p-clamp or bonding strap may be easily damaged by physical handling of the component, handling of the p-clamp or bonding strap itself, or vibration of the components.

It should thus be appreciated from the above that it would be desirable to provide an improved device assembly including a means for providing electrical bonding of the assembly for the discharge of static electricity during operation of the device assembly. Therefore, there is a need for a means for joining components in a device that will provide a low electrical resistance bonding path and thus permit the discharge of static electricity. Furthermore, other desirable features and characteristics of the present invention will become apparent from the subsequent detailed description of the invention and the appended claims, taken in conjunction with the accompanying drawings and this background of the invention.

### BRIEF SUMMARY

The present invention provides a bonding means for electrically coupling a first component and a second component at an interface. In one embodiment and by way of example only, the bonding means comprises at least one electrically conductive bonding puck positioned between the first component and the second component. The at least one electrically conductive bonding puck is disposed within a recess formed in at least one of the first component or the second component. Te at least one electrically conductive bonding puck is formed of an electrically conductive material and provides electrical bonding between the first component and the second component and establishes electrical continuity therebetween.

In another particular embodiment, and by way of example only, there is provided a bonding means for electrically coupling a first component and a second component at an interface wherein the bonding means comprises at least one electrically conductive bonding puck positioned between the first component and the second component. The at least one electrically conductive bonding puck is defined by a first planar surface, a second planar surface and a sidewall extending therebetween. The at least one electrically conductive bonding puck provides electrical bonding between the first component and the second component and establishes electrical continuity therebetween.

In yet another particular embodiment, and by way of example only, there is provided a valve assembly including a bonding means for electrically coupling a first component and a second component at an interface. The valve assembly comprises at least one valve body, an actuator housing, a servo housing, and an electrical bonding means electrically coupling the actuator housing and the servo housing at an interface. The at least one valve body includes a flow passage defined therein. The actuator housing has housed therein an actuator assembly for control of the at least one valve body. The servo housing has disposed therein a servo regulator for regulating the actuator assembly. The electrical bonding means comprises at least one electrically conductive bonding puck positioned between the actuator housing and the servo housing. The bonding puck is disposed within a recess formed in at least one of the actuator housing or the servo housing. The at least one electrically conductive bonding puck provides electrical bonding between the actuator housing and the servo housing and establishes electrical continuity therebetween.

Other independent features and advantages of the preferred bonding means will become apparent from the following detailed description, taken in conjunction with the accompanying drawings which illustrate, by way of example, the principles of the invention.

### BRIEF DESCRIPTION OF THE DRAWINGS

The present invention will hereinafter be described in conjunction with the following drawing figures, wherein like numerals denote like elements, and

FIG. 1 is an isometric view of a valve assembly including a first component and a second component according to an embodiment;

FIG. 2 is an isometric view of portion of the valve assembly of FIG. 1 according to an embodiment;

FIG. 3 is an isometric view of a bonding puck relative to the first component of FIG.;

FIG. 4 2 is an isometric view of portion of the second component of FIG. 2 according to an embodiment; and

FIG. 5 is an isometric view of a bonding puck according to an embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

The embodiment disclosed herein is described in sufficient detail to enable those skilled in the art to practice the invention, and it is to be understood that other embodiments may be utilized and that logical, mechanical and electrical changes may be made without departing from the scope of the present invention. Furthermore, it will be understood by one of skill in the art that although the specific embodiment illustrated below is directed at the electrical bonding of an actuator housing and a servo housing typically found in an aircraft, for purposes of explanation, the apparatus may be used in various other embodiments employing various types of components that are require electrical bonding. The following detailed description is, therefore, not to be taken in a limiting sense.

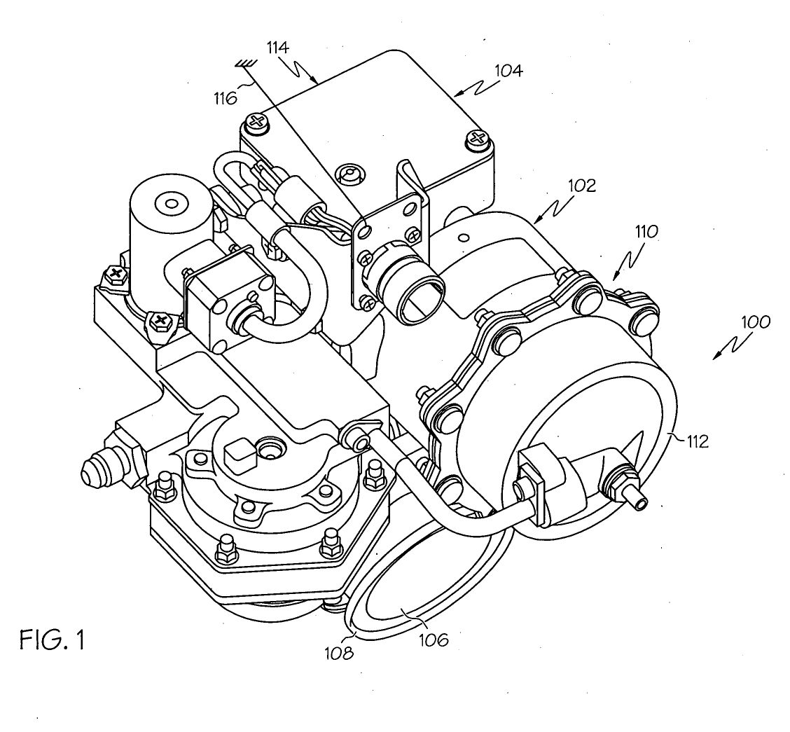

FIG. 1 is an isometric view of a conventional valve assembly 100 comprising a first component 102 and a second component 104 typically found in a number of valve applications, such as those found in aircraft embodiments. The valve assembly 100 is configured to control the flow of a fluid (e.g., pressurized air) through a flow body 106 (e.g., an airway) defined by a valve housing 108. A valve closure element (not shown) is typically disposed within the valve housing 108, and more particularly the flow body 106. Typically, the valve assembly 100, and more particularly the first component 102 comprises an actuator assembly 110, including an actuator housing 112 and the second component 104 comprises a servo housing 114. In this particular embodiment, the actuator assembly 110 includes an aluminum valve actuator, commonly used for the actuation of a flow body, such as the flow body 106. The valve closure element is coupled to the actuator assembly 110, and is configured to move between a closed position and an open position. In the closed position, the valve closure element substantially prevents airflow through the flow body 106. In contrast, when the valve closure element is in an open position, air may flow through the flow body 106. The valve assembly 100 may be pneumatically operated with a source of pressurized air. Those having ordinary skill in the art will appreciate from the description that follows that the exact form of the actuator, whether electromechanical or otherwise, forms no part of the present invention.

The valve assembly 100 further includes an electrical bonding means (not shown) generally comprised of a bonding puck (described presently) that electrically bonds the first component 102 to the second component 104. The bonding puck provides bonding and thus electric discharge of any static electricity that may build up in the first component 102 and the second component 104 during operation. The bonding puck provides a bonding path from the first component 102 through the second component 104 and to a ground, generally referenced 116.

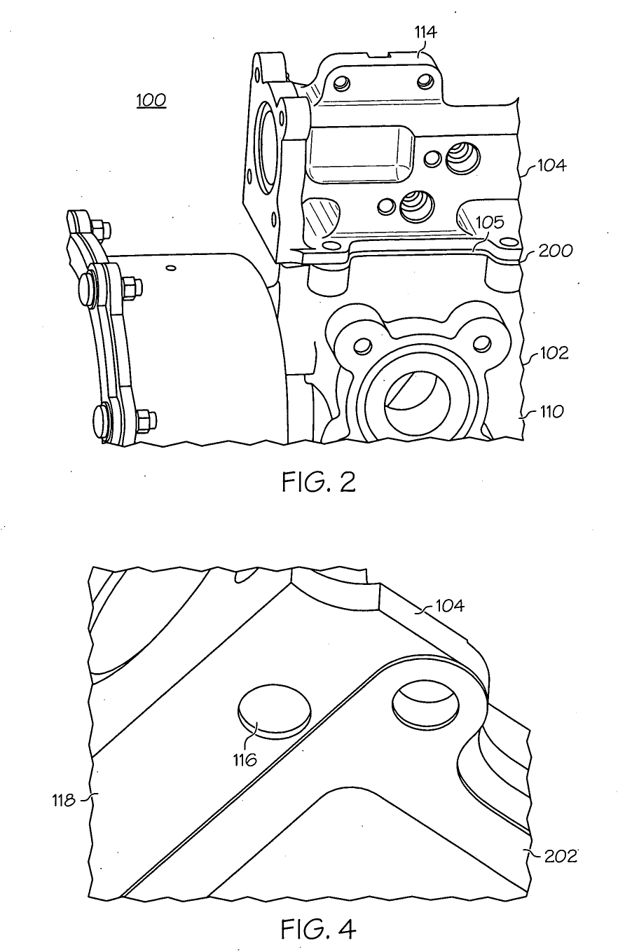

FIG. 2 is a simplified enlarged isometric view of a portion of FIG. 1. More specifically, illustrated is the first component 102 coupled to the second component 104 wherein a gasket 200 is positioned between the first component 102 and the second component 104 at an interface 105. The gasket 200 provides a seal between the first component 102 and the second component 104 and allows for fluid flow therebetween without leakage. In a preferred embodiment, the gasket 200 is formed of a non-electrically conductive material, such as an elastomeric, rubber, cork, or the like. The gasket 200 is held in place by compressive forces exerted upon it by the first component 102 and the second component 104. In addition an optional gasket recess (described presently) may be formed to further hold the gasket 200 in proper position.

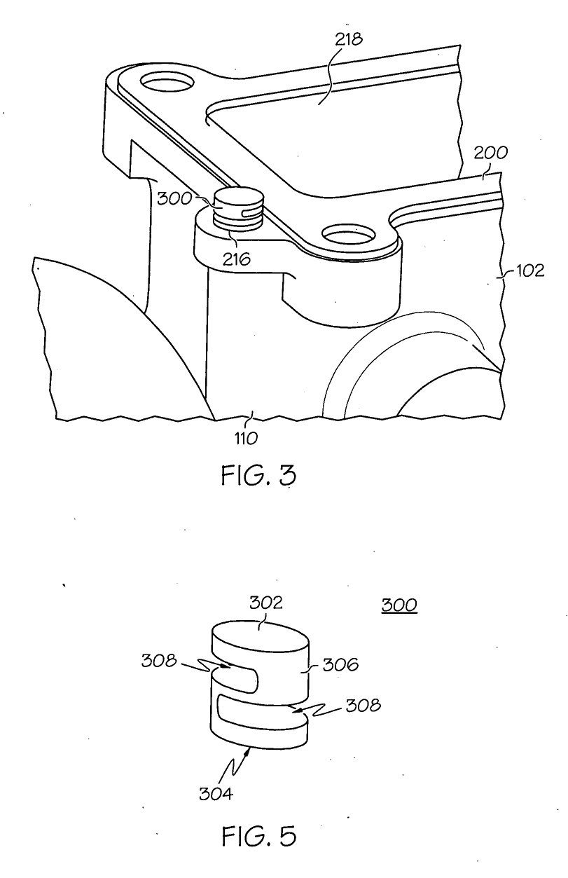

Referring now to FIG. 3, illustrated is an isometric view of a portion of the first component 102 and a portion of the gasket 200 that is positioned between the first component 102 and the second component when assembled. A bonding puck 300 is shown positioned relative to the first component 102. The bonding puck 300 is sized and shaped to allow for an interference fit with a recess (described presently) formed in the second component 104. The bonding puck 300 may optionally be positioned in a recess 216 formed in a surface 218 of the first component 102. In an alternate embodiment, the bonding puck 300 may simply abut the surface 218 of the first component 102 in that it is securely held in place to prevent displacement by the recess formed in the second component 104. In addition, the bonding puck 300 is held in place between the first component 102 and the second component 104 by a compressive force at the interface 105 (FIG. 2).

FIG. 4 is an isometric view of a portion of the second component 104, illustrating a portion of an optional gasket recess 202 and a recess 116 formed therein to aid in the positioning of the bonding puck 300. More specifically, illustrated is a surface 118 of the second component 104 having the recess 116 formed therein. The surface 118, when the second component 104 is in an assembled configuration relative to the first component 102, abuts the surface 218 (FIG. 3) of the first component 102. The recess 116 is formed having a depth, shape and size that cooperates with and provides an interference fit with the bonding puck 300 to minimize displacement of the bonding puck 300. The optional gasket recess 202 is formed having a depth, shape and size the cooperates with and provides for minimal displacement of the gasket 200.

Referring now to FIG. 5 illustrated is the bonding puck 300. In this particular embodiment the bonding puck 300 is generally cylindrical in shape. It should be understood that the bonding puck 300 does not have to be formed cylindrical and in an alternate embodiment may be of another shape dependent upon design need. The bonding puck 300 is defined by a first planar surface 302, a second planar surface 304 and a sidewall 306 extending therebetween. In a preferred embodiment, the first planar surface 302 contacts surface 118 of the second component 104 and the second planar surface 304 contacts surface 218 of the first component 102 when positioned correctly relative to the first component 102 and the second component 104. The bonding puck 300 is formed of an electrically conductive material, such as metallic material capable of sufficient electrical conduction to create a bonding path. In a preferred embodiment, the bonding puck is formed of an aluminum material.

The bonding puck 300 is configured to be maintained in compression during thermal excursions of at least one of the first component 102 or the second component 104. To accomplish this the bonding puck 300 may optionally include cut-out portions 308 to provide for flexibility of the bonding puck 300 in response to the compressive forces acting upon it when the first component 102 and the second component 104 are assembled together and during thermal excursions of the first component 102 or the second component 104. The cutouts 308 extend from the sidewall 306 toward a center axis of the bonding puck 300. The cutouts 308 make the bonding puck 300 more spring-like and compliant, helping the bonding puck 300 to conform to any thermal length changes that the first component 102 and the second component 104 will go through during operation of the valve assembly 100.

The bonding puck 300 provides an electrical path or bonding path for the discharge of static electricity that may buildup or from lightning strikes. When implemented into a valve assembly in an aircraft, the bonding puck 300 minimizes the buildup of static electricity and provides for the safe conduction of a lightning strike through the aircraft.

Accordingly, disclosed is a bonding means for device components, such as those commonly found in aircraft applications, that provides a means for electrically bonding two device components so as to assure low electrical resistance and provide an electrical bonding path.

While at least one exemplary embodiment has been presented in the foregoing detailed description of the invention, it should be appreciated that a vast number of variations exist. For example, although the specific embodiments illustrated are directed at joining a flow valve and an actuator, such as those found in an aircraft, the method and apparatus may be used in various embodiments employing various types of device components, such as in actuators, including pneumatic, hydraulic, electric, and electromechanical, starters, sensors, electronic controllers, etc. Furthermore, while the specific embodiment is disclosed as having a recess formed on the second component and an optional recess formed in the first component for placement of the bonding puck, it should be appreciated that the fabrication of a recess is design specific and may be formed on either component and/or on both components. Furthermore, the size and shape of the bonding puck and the recess are design specific and not limited to those illustrated. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A bonding means for electrically coupling a first component and a second component at an interface, the bonding means comprising at least one electrically conductive bonding puck positioned between the first component and the second component, wherein the at least one electrically conductive bonding puck is disposed within a recess formed in at least one of the first component or the second component, the at least one electrically conductive bonding puck formed of an electrically conductive material and providing electrical bonding between the first component and the second component and establishing electrical continuity therebetween.

2. A bonding means as claimed in claim 1, wherein the at least one electrically conductive bonding puck is formed of a metallic material.

3. A bonding means as claimed in claim 2, wherein the at least one electrically conductive bonding puck is formed of an aluminum material

4. A bonding means as claimed in claim 1, wherein the at least one electrically conductive bonding puck is defined by a first planar surface, a second planar surface and a sidewall extending therebetween.

5. A bonding means as claimed in claim 4, wherein the at least one electrically conductive bonding puck is substantially cylindrical.

6. A bonding means as claimed in claim 1, wherein the at least one electrically conductive bonding puck is configured to be maintained in compression during thermal excursions of at least one of the first component or the second component.

7. A bonding means as claimed in claim 6, wherein the at least one electrically conductive bonding puck includes a spring loading feature.

8. A bonding means as claimed in claim 7, wherein the at least one electrically conductive bonding puck includes a plurality of cut-outs.

9. A bonding means for electrically coupling a first component and a second component at an interface, the bonding means comprising at least one electrically conductive bonding puck positioned between the first component and the second component, the at least one electrically conductive bonding puck defined by a first planar surface, a second planar surface and a sidewall extending therebetween, the at least one electrically conductive bonding puck providing electrical bonding between the first component and the second component and establishing electrical continuity therebetween.

10. A bonding means as claimed in claim 9, wherein the at least one electrically conductive bonding puck is disposed within a recess formed in at least one of the first component or the second component.

11. A bonding means as claimed in claim 9, wherein the at least one electrically conductive bonding puck is disposed within a recess formed in the first component and a recess formed in the second component.

12. A bonding means as claimed in claim 9, wherein the at least one electrically conductive bonding puck is configured to be maintained in compression during thermal excursions of at least one of the first component or the second component.

13. A bonding means as claimed in claim 12, wherein the at least one electrically conductive bonding puck includes a spring loading feature.

14. A bonding means as claimed in claim 13, wherein the at least one electrically conductive bonding puck includes cutout portions extending parallel to the first planar surface and the second planar surface.

15. A bonding means as claimed in claim 9, wherein the at least one electrically conductive bonding puck is formed of an electrically conductive metal material.

16. A bonding means as claimed in claim 15, wherein the at least one electrically conductive bonding puck is formed of an aluminum material.

17. A bonding means as claimed in claim 9, wherein the first component is an actuator assembly and the second component is a servo housing.

18. A valve assembly including a bonding means for electrically coupling a first component and a second component at an interface, the valve assembly comprising:
at least one valve body having a flow passage defined therein;
an actuator housing having housed therein an actuator assembly for control of the at least one valve body;
a servo housing having disposed therein a servo regulator for regulating the actuator assembly; and
an electrical bonding means electrically coupling the actuator housing and the servo housing at an interface, the electrical bonding means comprising:
at least one electrically conductive bonding puck positioned between the actuator housing and the servo housing, wherein the bonding puck is disposed within a recess formed in at least one of the actuator housing or the servo housing, the at least one electrically conductive bonding puck providing electrical bonding between the actuator housing and the servo housing and establishing electrical continuity therebetween.

19. A valve assembly as claimed in claim 18, wherein the at least one electrically conductive bonding puck is configured to be maintained in compression during thermal excursions of at least one of the first component or the second component.

20. A valve assembly as claimed in claim 18, wherein the at least one electrically conductive bonding puck is formed of an electrically conductive metal material.
